(19) United States
(12) Patent Application Publication
(10) Pub. No.: US 2023/0381559 A1
(43) Pub. Date: Nov. 30, 2023

(54) FUEL BREAK WITH INTEGRAL WATERING SYSTEM

(71) Applicant: Gary E. Abeles, Verona, NJ (US)

(72) Inventor: Gary E. Abeles, Verona, NJ (US)

(21) Appl. No.: 18/026,430

(22) PCT Filed: Aug. 19, 2021
(86) PCT No.: PCT/US2021/046598

§ 371 Date: Mar. 15, 2023

Related U.S. Application Data
(60) Provisional application No. 63/081,101, filed on Sep. 21, 2020.

(51) Int. Cl. A62C 3/02; A62C 35/13

(52) U.S. Cl. CPC A62C 3/0278; A62C 35/13; A01G 23/00

(57) ABSTRACT

A fuel break with integral watering system includes watering towers with associated pumps and water supplies that apply water to fuel break vegetation when needed, such as during a drought and/or when a fire is approaching. Water can be delivered by pipes from a remote water source, and/or collected as runoff water in reservoirs below the watering towers. Sensors can monitor water content of the reservoirs, and/or moisture content of surrounding soil, vegetation, and/or air. The towers can be remotely powered by wires, and/or by batteries recharged by solar panels. The watering system can be configured to apply water both to tall vegetation and to ground vegetation. Super-absorbent polymer added to the fuel break can absorb and retain rain water and water from the towers. Reforestation can include planting fire resistant trees in bunches, locating the towers near the bunches, and/or relocating power lines below grade.

### RELATED APPLICATIONS

This application claims the benefit of U.S. Provisional Application No. 63/081,101, filed Sep. 21, 2020, which is herein incorporated by reference in its entirety for all purposes.

### FIELD OF THE INVENTION

The invention relates to fire prevention and mitigation, and more particularly, to preventing and recovering from fires in heavily vegetated areas such as forests.

### BACKGROUND OF THE INVENTION

The prevention and minimization of fires, and the recovery from fires, in heavily vegetated areas that are unpopulated, or only sparsely populated, has always been a challenge. Furthermore, recent trends in global climate change have resulted in consistently higher temperatures and persistent droughts in many areas, which in turn have increased the risks and the occurrences of major fires in wilderness and other sparsely populated areas. In particular, fifteen of the largest wildfires that have ever been recorded in the United States have occurred within the past ten years.

For ease of expression, the term “forest fire” is used generically herein to refer to any fire in any heavily vegetated area that is a wilderness area, an otherwise unpopulated area, or a sparsely populated area, and the term “forest” is used generically herein to refer to any such heavily vegetated area, whether or not the vegetation is primarily trees. The terms “trees” and “ground cover” refer to any type of vegetation that is relatively tall and relatively short, respectively.

Often, in the aftermath of a forest fire, an effort is made to apply “reforestation” to the damaged area. With reference to FIG. 1A, the reforestation typically includes the planting of new trees 102 (or other vegetation) that are the same or similar species as were destroyed by the fire. Motivations include a desire to return the region to its pre-fire status. Often, the new trees 102 include any or all of pine, evergreen, acacia, Douglas fir, black spruce, white spruce, balsam fir and other fir trees, which tend to grow quickly, thereby shortening the recovery time of the burned region. Nevertheless, these varieties of tree 102 are not fire resistant. In fact, they produce and exude sap that can help to accelerate and rapidly spread a forest fire.

In addition, reforestation typically includes the creation of firebreaks 100, which are strips of land, usually between 15 and 20 feet wide, where all indigenous organic matter and vegetation has been removed, leaving a mineral or soil base. The intent is to deny fuel to any future forest fire, so that a fire will have difficulty crossing the firebreak. Often, the firebreaks 100 also serve as roads that can be traversed by fire service personnel, thereby providing a means of access to otherwise remote areas for fire fighters and their equipment.

Frequently, fuel-breaks 104 are provided adjacent to one or both sides of a firebreak 100. A fuel-break 104 is a strip of land where fuel for a potential fire (living or dead trees, brush, dead branches, etc.) has been reduced so as to limit the spread of fire near the firebreak 100. This is sometimes accomplished by thinning and/or pruning of trees or, in the case of reforestation, spacing the replacement trees apart, so that embers from fires will tend to fall to the ground rather than onto other trees, thereby allowing firefighters to more easily extinguish the flames.

With reference to FIG. 1B, in some instances the reforestation includes planting the new trees in groupings or “bunches” 108, especially for those trees that are near to a firebreak 100. This approach makes it more difficult for a fire to spread from one bunch 108 to another bunch 108, because the bunches 108 are separated by greater distance than would be provided between the same number of trees when planted at equal distances from each other.

Often, grass is planted within fuel breaks 104 to minimize erosion and to exclude other vegetation from taking root in the fuel breaks 104. With reference to FIG. 1C, when vegetation is not intentionally planted within a fuel break 104, opportunistic vegetation 106 often takes root instead. In addition, opportunistic vegetation 106 may emerge within the firebreaks 100 themselves. Unfortunately, the planted grass and/or encroaching opportunistic vegetation 106 within a fuel break 104 or fire break 100 often does not survive, for example in times of drought, and as a result the dead vegetation, together with any leaves, needles, and/or other dead vegetation that happens to collect within the fuel break 104 or fire break 100, can provide tinder that may be even more flammable than the surrounding, living trees 102 and other vegetation. Furthermore, over time this dead vegetation can become a natural compost that encourages the growth of larger, more flammable bushes and shrubs 106 within the fuel break 104 or fire break 100, thereby eliminating the utility of the fuel break 104 for resisting the spread of fires.

What is needed, therefore, is an apparatus and method for reducing the likelihood of forest fires, and for recovering from forest fires while minimizing the likelihood of future forest fires in the same area.

### SUMMARY OF THE INVENTION

The present invention is an apparatus and method for reducing the likelihood of forest fires, and for recovering from forest fires such that the likelihood of future forest fires in the same area is minimized. According to the present invention, a watering system is included in a fuel break, and is used to provide water to grass and/or other vegetation within the fuel break when a fire is approaching. In embodiments, the disclosed method further includes applying water to the fuel break during periods of drought, so as to maintain living vegetation within the fuel break, and thereby reduce the accumulation of deceased vegetation in the fuel break. Embodiments further include applying water to the fuel break in anticipation of a planned backfire that may be deliberately set so as to clear the firebreak and/or adjacent fuel breaks of dead vegetation.

The disclosed watering system includes at least one watering tower that rises above grade, as well as a pump, a water conduit, and a water distribution outlet, such as a sprinkler head, that are configured to bring water up the watering tower and distribute it onto the fuel break. In embodiments, watering “towers” are provided having differing heights and/or other characteristics. For example, in some embodiments the towers are configured to apply water both to trees and to ground vegetation. In other embodiments, taller towers are provided to reduce the dryness of trees that are within or near the fuel-break, while shorter towers are configured to provide water to grass and/or other ground covering vegetation that is included in the fuel-break. In various embodiments, reforested trees are planted in bunches, and at least some of the water towers are concentrated proximal to the bunches.

The water that is applied to the fuel break by the present invention can come from any combination of several possible sources, depending on the embodiment. Some embodiments include supply pipes that deliver water to the watering tower from remote water sources, which can be any combination of sources such as municipal water systems, wells, streams, rivers, lakes, and ponds.

Embodiments further include a water reservoir that extends beneath grade, for example beneath at least one of the watering towers. The water reservoir can be filled by water delivery pipes from the above-mentioned water sources, and/or by manual delivery of water, for example by water tanker trucks that periodically traverse the firebreak system. The water reservoir can also be replenished by run-off water from local rain that is collected through drain openings at or near grade and filtered to remove any dirt and debris. The runoff water can include excess water that is applied by the watering system but is not absorbed by the vegetation or surrounding soil, thereby improving the water efficiency of the system.

Level sensors can be included in the water reservoir, and embodiments include moisture sensors that sense the humidity and/or moisture content of the surrounding soil and vegetation. Any or all of the sensors can report their measurements to a central controller by wired and/or wireless communication.

Electricity for the pump and local controller can be provided via wired electrical conduits, and/or by solar panels included with the watering towers that provide electricity to a rechargeable battery. The pumps can be activated under local control, for example in response to measurements made by the moisture sensors. In embodiments, the sensors can be monitored and/or the pump can be remotely controlled by wired or wireless communications from a remote, central control center.

Some or all of the watering towers can be disguised to resemble trees or other local vegetation, thereby reducing the visual impact of the watering towers and of the fuel break.

In embodiments, the water efficiency of the disclosed system is further enhanced by applying a super-absorbent polymer (SAP) to the fuel break that is able to absorb at least 25 times its weight of water. The SAP functions to increase the ability of the soil in the fuel break to absorb and maintain water, both as delivered by the watering system and by natural rainfall, thereby minimizing wasted water runoff and further reducing plant mortality during droughts.

Embodiments further include reforestation within the fuel break by trees that do not produce and exude an abundance of excess flammable sap, such as hardwood, maple, poplar and cherry, trembling aspen, balsam poplar, and white birch, and/or inclusion in the fuel break of fire-resistant plants and shrubs, such as hedging roses, bush honeysuckles, currant, cotoneaster, sumac and shrub apples.

In embodiments, the towers are also used to moisten ground vegetation in the fuel break in advance of a backfire that is set to remove dead vegetation from the fire break and/or the fuel breaks. In some of these embodiments, the watering towers are configured to apply water both to trees and to ground cover. In other embodiments, separate, relatively taller watering towers apply water to trees, while relatively shorter water towers apply water to ground vegetation. If the trees are planted in bunches, the relatively taller watering towers can be located proximate the bunches, while the relatively shorter watering towers can be located in between the bunches. Embodiments further include relocating below grade any power lines that are present in or near the fire break or fuel break.

A first general aspect of the present invention is a system for impeding a spread of fires within a vegetated area. The system includes a fuel break, a watering tower configured to extend above grade, the watering tower being located within or proximal to the fuel break, a water distribution outlet cooperative with the watering tower, a water conduit configured to provide liquid communication between a water source and the water distribution outlet, and a water pump configured to draw water from the water source and to cause the water to be expelled through the water distribution outlet onto the fuel break.

In embodiments, the water source comprises a source of water that is separated from the watering tower by a distance of at least 10 yards. In some of these embodiments the water source comprises a municipal water source, a stream, a river, a well, a pond, or a lake.

In any of the preceding embodiments, the water source can include a water reservoir provided below grade and located proximal to the watering tower. In some of these embodiments water reservoir is configured to receive water from a water-bearing vehicle. In any of these embodiments, the water reservoir can be configured to receive water from at least one drain inlet located proximal to grade that is positioned to receive run-off water. In some of these embodiments the drain inlet includes a filter configured to remove debris from the run-off water. And any of these embodiments can further include at least one sensor configured to determine a quantity of water contained within the water reservoir.

Any of the preceding embodiments can further include a water-absorbent material applied to the fuel break, said water-absorbent material being able to absorb at least 25 times its weight in water.

Any of the preceding embodiments can further include a solar panel and a rechargeable battery, the rechargeable battery being configured to provide electrical power to the water pump and the solar panel being configured to recharge the rechargeable battery.

Any of the preceding embodiments can further include a local controller configured to activate and deactivate the water pump. In some of these embodiments the local controller is configured to communicate with a central controller that is remote from the watering tower, said communication being at least one of wired and wireless communication.

Any of the preceding embodiments can further include a moisture sensor that is configured to measure a moisture content of at least one of vegetation growing in the fuel break, soil present in the fuel break, and air proximate the fuel break.

In any of the preceding embodiments, the watering tower can be configured to approximate an outward appearance of vegetation that is growing within the fuel break.

In any of the preceding embodiments, the vegetation within the fuel break can include trees that are planted in bunches, and the watering tower can be located proximate one of the bunches.

In any of the preceding embodiments, the watering tower can be configured to apply water both to trees proximate the watering tower and to ground vegetation proximate the watering tower.

In any of the preceding embodiments, the watering tower can be included in a watering system that comprises a plurality of watering towers, and said watering towers can include at least one relatively taller watering tower configured to apply water to trees, and at least one relatively shorter watering tower configured to apply water to ground vegetation.

A second general aspect of the present invention is a method of reforesting a fuel break after occurrence of a fire therein, the fuel break being adjacent to a firebreak. The method includes adding fuel breaks adjacent to each side of the firebreak, if not already present, planting replacement vegetation in the fuel breaks, and installing a watering tower according to any embodiment of the first general aspect proximate the vegetation.

In some of these embodiments the replacement vegetation is fire-resistant. In some of these embodiments, the fire-resistant vegetation includes at least one of hardwood trees, maple trees, poplar trees, cherry trees, trembling aspen trees, balsam poplar trees, white birch hedging roses, bush honeysuckles, currant, cotoneaster, sumac and shrub apples.

In any of the preceding embodiments, planting the replacement vegetation can include planting a plurality of trees in bunches, and installing the watering tower can include installing the watering tower proximate one of the bunches. In some of these embodiments, the watering tower is a relatively tall watering tower, the watering tower is part of a watering system that further comprises a relatively short watering tower, and the method further comprises locating the relatively shorter watering tower between two of the bunches.

Any of the preceding embodiments can further include widening the firebreak and/or fuel breaks such that the firebreak has a width of at least 100 ft., and such that the total combined width of the firebreak and adjacent fuel breaks is at least 200 ft. 24. The method of claim 18, further comprising relocating below grade a powerline that was previously located above grade in the firebreak and/or the fuel break.

Any of the preceding embodiments can further include removing all vegetation in the fuel breaks that is within 125 ft. or more of an electrical transformer and/or an electrical power station. 26.

A third general aspect of the present invention is a method of maintaining vegetation within a fuel break that is located adjacent to a firebreak, and that includes a watering tower according to any embodiment of the first general aspect. The method includes at least one of: causing the watering tower to apply water to the vegetation when a fire is approaching the fuel break, causing the watering tower to apply water to the vegetation during a drought, and causing the watering tower to apply water to the vegetation immediately before and/or during application of a backfire to at least one of the firebreak and the fuel break.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a perspective view of a firebreak and fuel break of the prior art shortly after implementation thereof;

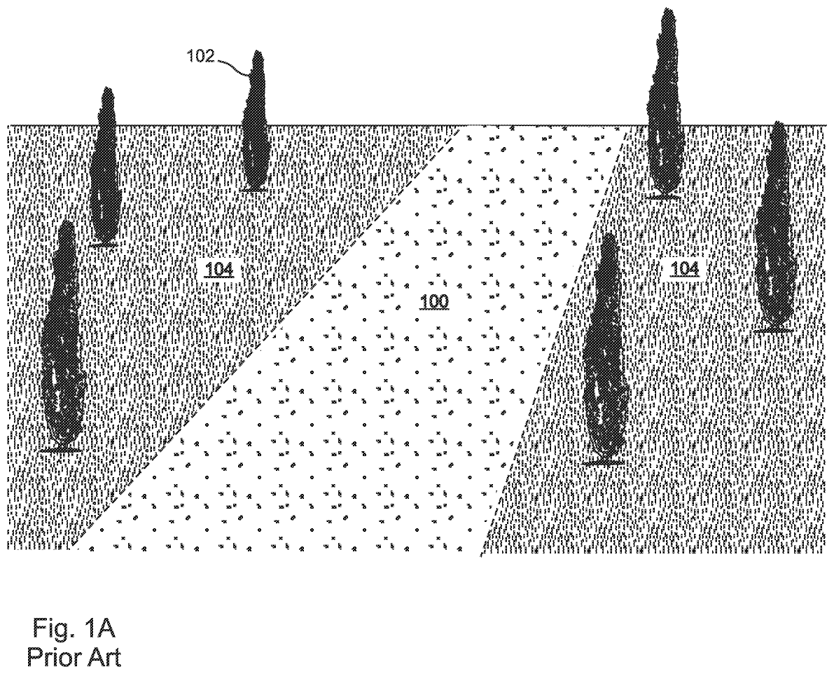

FIG. 1B is a perspective view of a firebreak and fuel break of the prior art similar to FIG. 1A, but wherein the reforestation trees are planted in bunches;

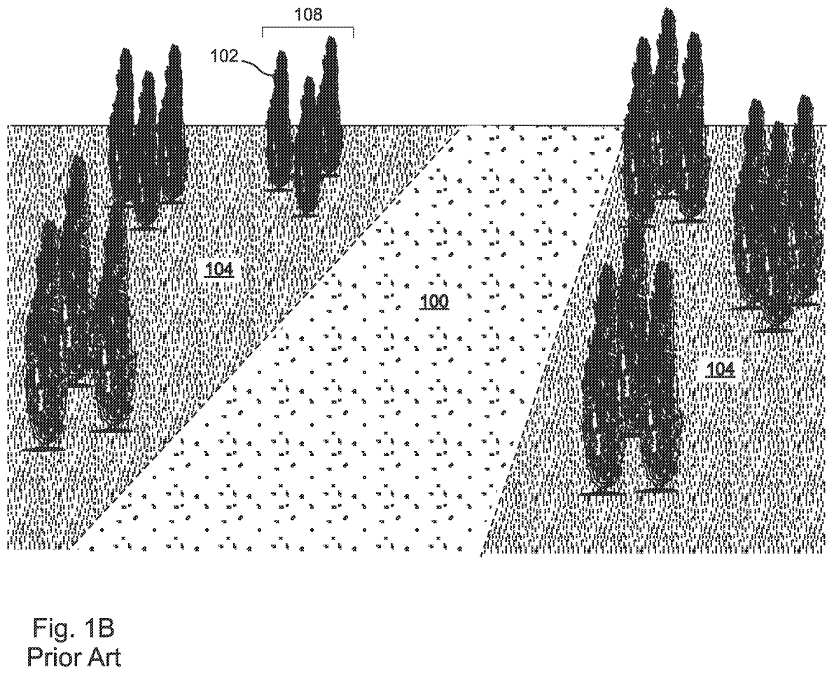

FIG. 1C is a perspective view of the firebreak and fuel break of FIG. 1 shown several years after implementation thereof;

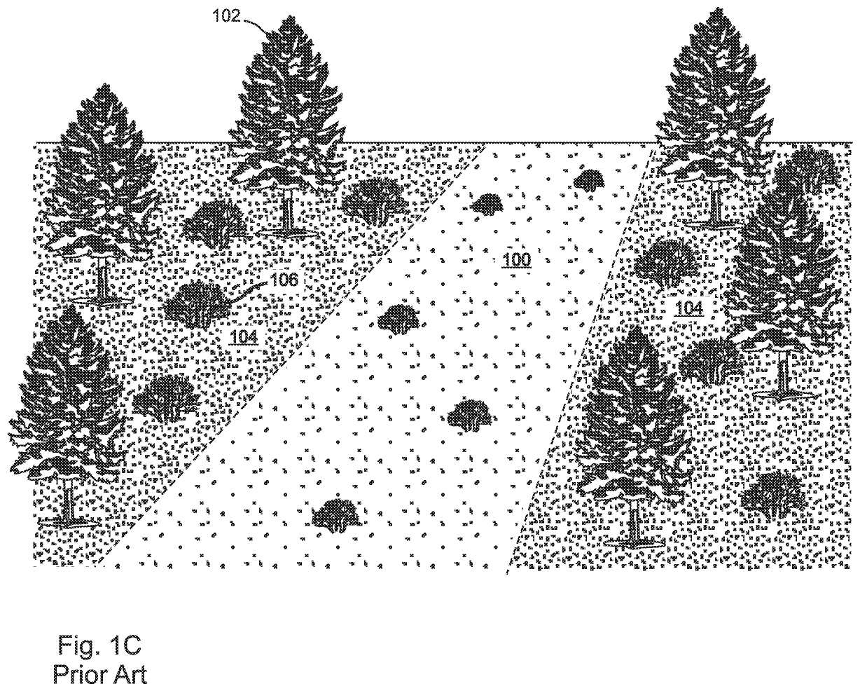

FIG. 2A is a perspective view of an embodiment of the present invention as applied to the fuel breaks of FIG. 1A;

FIG. 2B is a perspective view of an embodiment of the present invention as applied to the fuel breaks of FIG. 1B;

FIG. 3 is a cross-sectional view of a watering tower in an embodiment of the present invention;

FIG. 4 is a perspective view of an embodiment similar to FIG. 2A, but in which the watering towers are configured to resemble trees growing in the fuel break;

FIG. 5 is a perspective view of an embodiment in which the watering towers are located along the sides of the firebreak, and fire-resistant trees are planted in the fuel break;

FIG. 6 is a flow diagram that illustrates a method embodiment of recovering and reforesting a fuel break after a forest fire; and

FIG. 7 is a flow diagram that illustrates a method of maintaining a fuel break according to an embodiment the invention.

### DETAILED DESCRIPTION

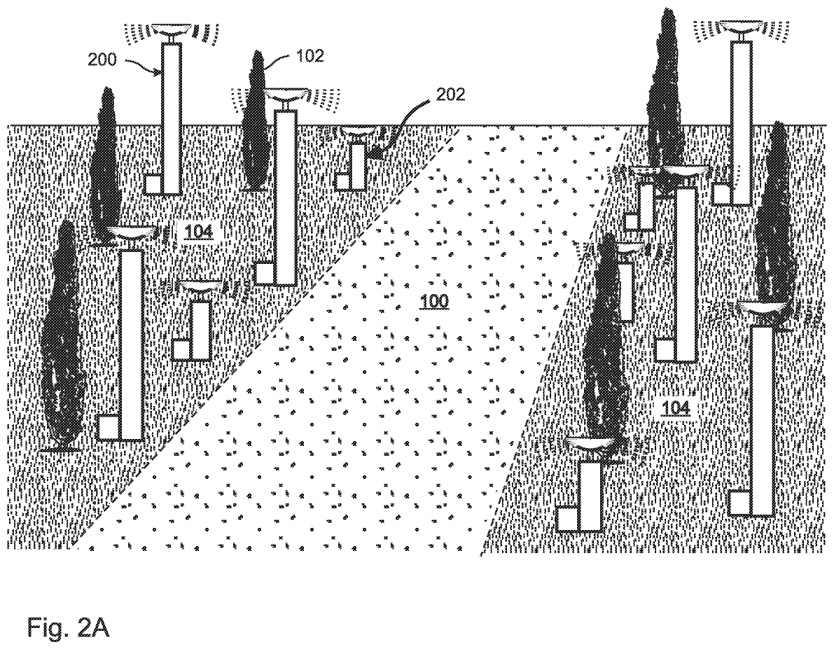

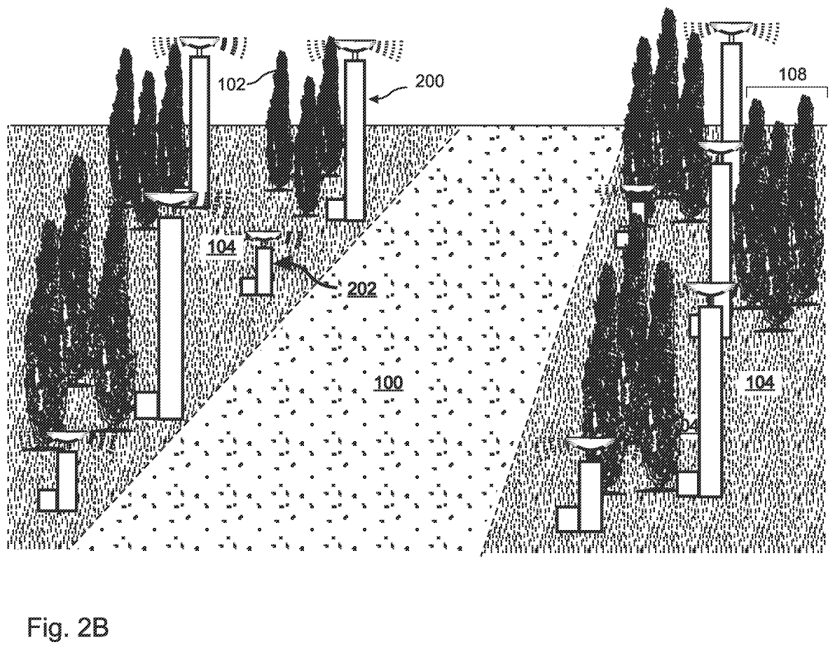

The present invention is an apparatus and method for reducing the likelihood of forest fires, and for recovering from forest fires such that the likelihood of future forest fires in the same area is minimized. With reference to FIG. 2A, the present invention includes an integral watering system 200, 202 that is implemented in or proximal to a fuel break 104, and is used to provide water as needed to trees 102, grass, and/or other vegetation within the fuel break 104. In the embodiment of FIG. 2A, the watering system includes relatively tall watering towers 200 that are configured to apply water mainly to the upper portions of trees 102 within the fuel break 104, as well as relatively shorter watering towers 202 that are configured to apply water to ground vegetation within the fuel break 104.

FIG. 2B illustrates an embodiment similar to FIG. 2A, but wherein the newly reforested trees have been planted in “bunches” 108, and wherein the relatively taller watering towers 200 have been located proximate the bunches 108, while the relatively shorter watering towers 202 have been located between the bunches.

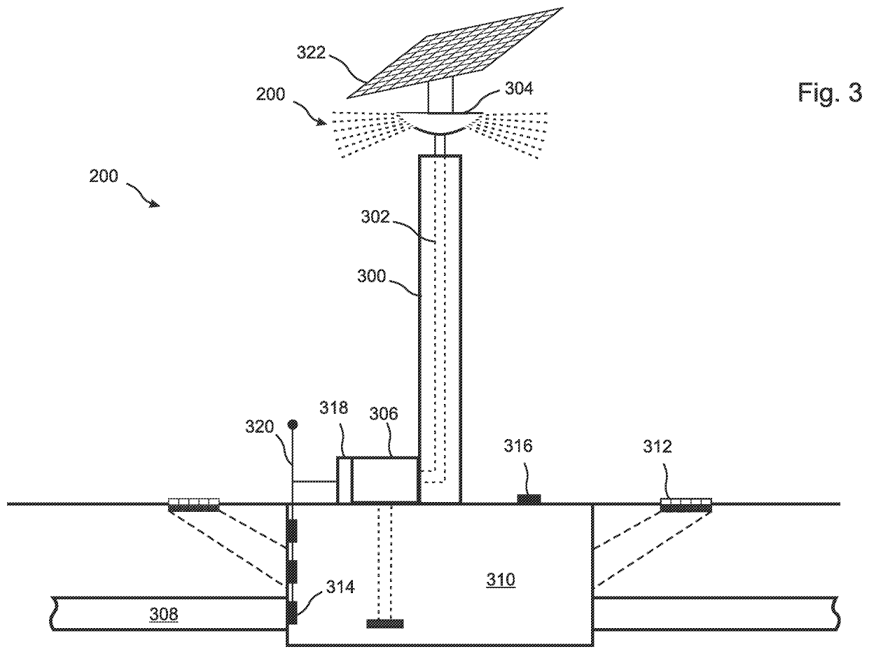

With reference to FIG. 3, the disclosed watering system includes at least one watering tower 300 which is either hollow or contains a water pipe 302, a pump 306, and a water distribution outlet 304, which in the embodiment of FIG. 3 is a sprinkler head 304. These elements 300, 302, 304, 306 are configured to bring water up the watering tower 300 and distribute it onto the fuel break 104. In some embodiments, the water distribution outlets 304 are normally near or below grade, and are automatically raised above grade when water is delivered to the water distribution outlets 304 by the pumps 306.

The water that is applied to the fuel break 104 by the present invention can come from any combination of several possible sources, depending on the embodiment. The embodiment of FIG. 3 includes water supply pipes 308 that deliver water to the watering tower 300 from remote water sources, which can be, or can include, municipal water systems, wells, rivers, streams, lakes, and ponds. The illustrated embodiment further includes a water reservoir 310 that extends beneath grade. In the illustrated embodiment, the water reservoir 310 is beneath the watering tower 300. The water reservoir 310 can be filled by water supply pipes 308, and/or by manual delivery of water, for example by water tanker trucks (not shown) that periodically traverse the firebreak 100. In embodiments, the water reservoir 310 can be replenished by run-off water from local rain that is collected through drain openings 312 at or near grade and filtered to remove any dirt and debris. The runoff water can also include excess water that is applied to the fuel break 104 by the watering system 200 but is not absorbed by the vegetation or surrounding soil, thereby improving the water efficiency of the system.

Level sensors 314 can be included in the water reservoir 310 that can be interrogated to determine how much water is in the water reservoir 310. Furthermore, embodiments include moisture sensors 316 that are configured to sense the humidity or moisture content of the surrounding soil, vegetation, and/or air. Any or all of the sensors 314, 316 can report their measurements to a local controller 318, which can forward the information to a remote, central control center by wired and/or wireless communication 320. In embodiments, the local controller 318 is further able to accept commands from the remote central control center via wired or wireless communications 320.

Electricity for the pumps 306 and local controller 318 can be provided by wired electrical conduits, and/or by batteries (not shown) that are recharged by solar panels 322 included with the watering towers 300. The pumps 306 can be activated under local control, for example by the local controller 318 in response to measurements made by the moisture sensors 316. In embodiments, the pump 306 can be remotely controlled by wired or wireless communications from the central control center to the local controller 318.

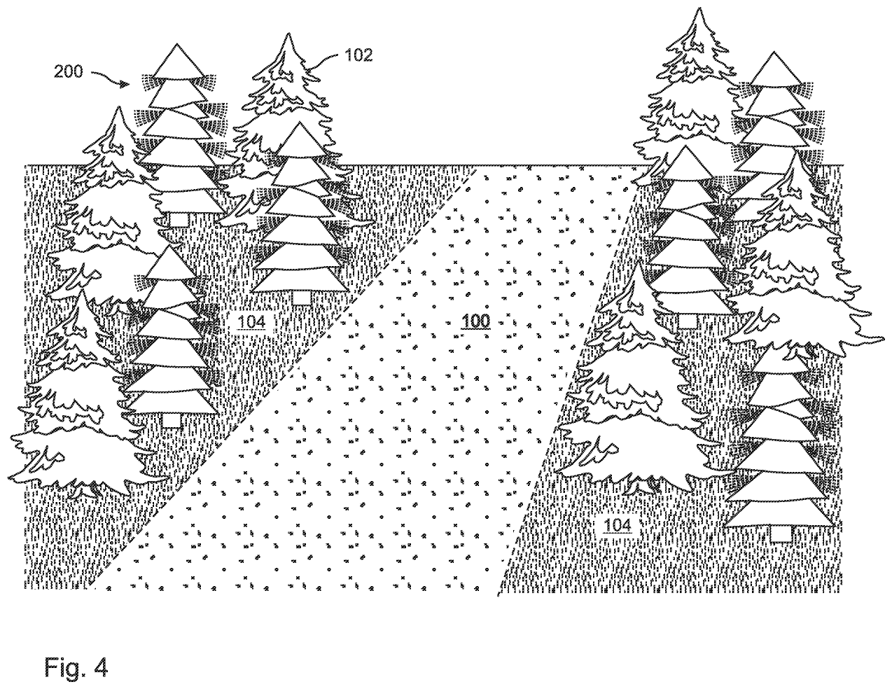

With reference to FIG. 4, some or all of the watering towers 200 can be configured to resemble trees or other local vegetation, thereby reducing the visual impact of the watering towers and of the fuel break 104 on the visible appearance of the area.

In embodiments, the water efficiency of the disclosed watering system is further enhanced by applying a super-absorbent polymer (SAP) or other superabsorbent material to the fuel break 104, where a superabsorbent material is defined herein as a material that is able to absorb and retain up to 25 times its weight in water. The superabsorbent material functions to increase the ability of the soil in the fuel break to absorb and maintain water, both as delivered by the watering system and by natural rainfall, thereby minimizing wasted water runoff and further reducing plant mortality during droughts.

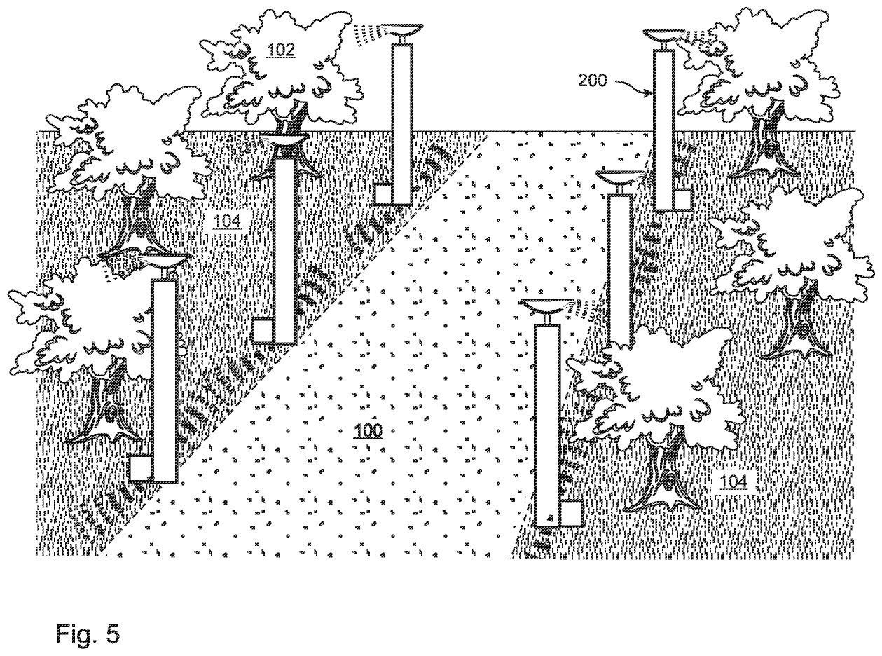

With reference to FIG. 5, in embodiments the watering towers 200 are placed along one or both sides of the firebreak 100, rather than further within the fuel break 104, thereby facilitating maintenance of the watering towers 200 and associated apparatus by making them accessible to vehicles that traverse the system of firebreaks 100.

Embodiments further include reforesting the fuel break 104 with fire-resistant trees 500 that do not exude an excess of highly flammable sap, such as hardwood, maple, poplar and cherry, trembling aspen, balsam poplar, and white birch, and/or inclusion in the fuel break of fire-resistant plants and shrubs, such as hedging roses, bush honeysuckles, currant, cotoneaster, sumac and shrub apples. Rather than including separate, shorter towers 202, the towers 200 in the embodiment of FIG. 5 are configured to apply water both to the trees 500 and to the ground vegetation.

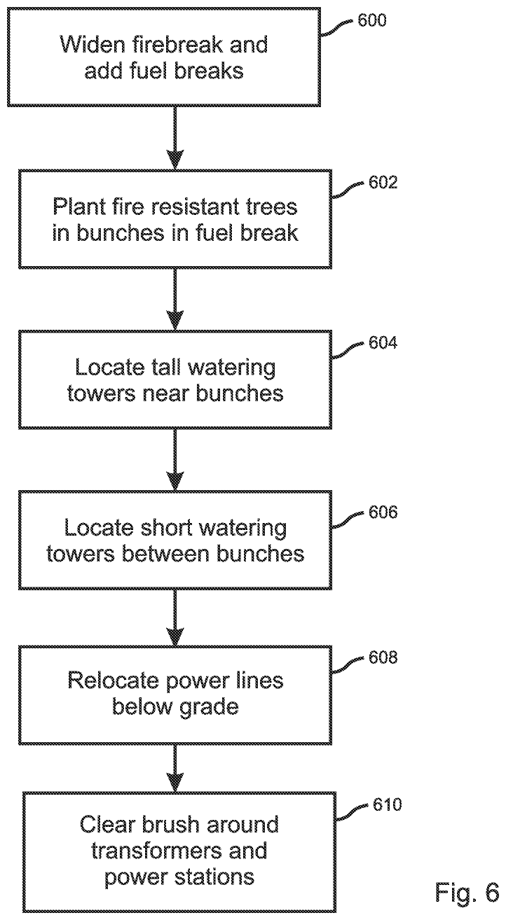

With respect to FIG. 6, methods of recovering from a forest fire, according to embodiments of the invention, include any combination of one or more of the following steps: widening 600 the firebreak 100 to at least 100 feet and adding fuel breaks 104, preferably such that the total width of the firebreak 100 and the fuel breaks 104 is between 200 ft and 250 ft; planting 602 fire-resistant trees 500 in bunches 108 within the fuel breaks 104; implementing a watering system that locates 604 relatively taller towers 200 proximate the tree bunches 108, while locating 606 relatively shorter watering towers 202 between the bunches 108; relocating 608 below grade any power lines that are present within the fire break 100 or fuel break 104; and clearing bush 610 around any transformers and/or power stations that may be present in the firebreak 100 and/or fuel breaks 104, preferably to a distance of 250 ft from each transformer and/or power station.

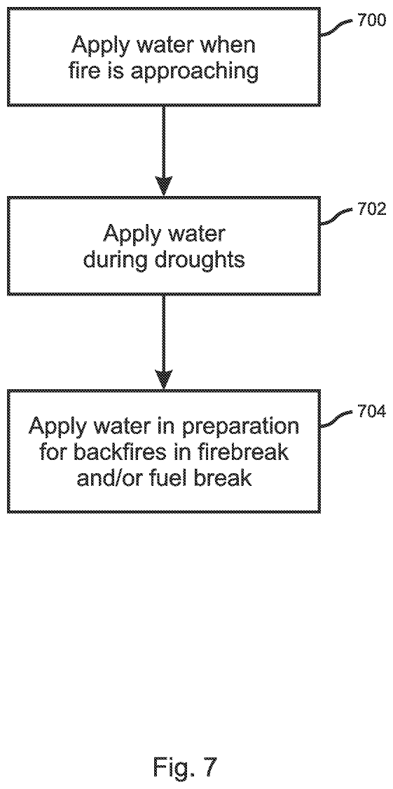

With reference to FIG. 7, methods of maintaining firebreaks and fuel breaks according to embodiments of the present invention include applying water to a fuel break when a fire is approaching 700, applying water to the fuel break during droughts, even when no fire is approaching 702, and applying water to the fuel break in combination with creating a backfire in the fire break 100 and/or fuel breaks 104, so as to eliminate any dead vegetation within the firebreak 704.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the invention is not limited to just these forms, but is amenable to various changes and modifications without departing from the spirit thereof. The disclosure presented herein does not explicitly disclose all possible combinations of features that fall within the scope of the invention. The features disclosed herein for the various embodiments can generally be interchanged and combined into any combinations that are not self-contradictory without departing from the scope of the invention. In particular, the limitations presented in dependent claims below can be combined with their corresponding independent claims in any number and in any order without departing from the scope of this disclosure, unless the dependent claims are logically incompatible with each other.

1. A system for impeding a spread of fires within a vegetated area, the system comprising:
a fuel break;
a watering tower configured to extend above grade, the watering tower being located within or proximal to the fuel break;
a water distribution outlet cooperative with the watering tower;
a water conduit configured to provide liquid communication between a water source and the water distribution outlet; and
a water pump configured to draw water from the water source and to cause the water to be expelled through the water distribution outlet onto the fuel break.

2. The system of claim 1, wherein the water source comprises a source of water that is separated from the watering tower by a distance of at least 10 yards.

3. The system of claim 2, wherein the water source comprises a municipal water source, a stream, a river, a well, a pond, or a lake.

4. The system of claim 1, wherein the water source comprises a water reservoir provided below grade and located proximal to the watering tower.

5. The system of claim 4, wherein the water reservoir is configured to receive water from a water-bearing vehicle.

6. The system of claim 4, wherein the water reservoir is configured to receive water from at least one drain inlet located proximal to grade that is positioned to receive run-off water.

7. The system of claim 6, wherein the drain inlet includes a filter configured to remove debris from the run-off water.

8. The system of any of claim 4, further comprising at least one sensor configured to determine a quantity of water contained within the water reservoir.

9. The system of claim 1, further comprising a water-absorbent material applied to the fuel break, said water-absorbent material being able to absorb at least 25 times its weight in water.

10. The system of claim 1, further including a solar panel and a rechargeable battery, the rechargeable battery being configured to provide electrical power to the water pump and the solar panel being configured to recharge the rechargeable battery.

11. The system of claim 1, further comprising a local controller configured to activate and deactivate the water pump.

12. The system of claim 11, wherein the local controller is configured to communicate with a central controller that is remote from the watering tower, said communication being at least one of wired and wireless communication.

13. The system of claim 1, further comprising a moisture sensor that is configured to measure a moisture content of at least one of:
vegetation growing in the fuel break;
soil present in the fuel break; and
air proximate the fuel break.

14. The system of claim 1, wherein the watering tower is configured to approximate an outward appearance of vegetation that is growing within the fuel break.

15. The system of claim 1, wherein the vegetation within the fuel break includes trees that are planted in bunches, and the watering tower is located proximate one of the bunches.

16. The system of claim 1, wherein the watering tower is configured to apply water both to trees proximate the watering tower and to ground vegetation proximate the watering tower.

17. The system of claim 1, wherein the watering tower is included in a watering system that comprises a plurality of watering towers, and wherein said watering towers include at least one relatively taller watering tower configured to apply water to trees, and at least one relatively shorter watering tower configured to apply water to ground vegetation.

18. A method of reforesting a fuel break after occurrence of a fire therein, the fuel break being adjacent to a firebreak, the method comprising:
adding fuel breaks adjacent to each side of the firebreak, if not already present;
planting replacement vegetation in the fuel breaks; and
installing a watering tower according to claim 1 proximate the vegetation.

19. The method of claim 18, wherein the replacement vegetation is fire-resistant.

20. The method of claim 19, wherein the fire-resistant vegetation includes at least one of hardwood trees, maple trees, poplar trees, cherry trees, trembling aspen trees, balsam poplar trees, white birch hedging roses, bush honeysuckles, currant, cotoneaster, sumac and shrub apples.

21. The method of claim 18, wherein planting the replacement vegetation includes planting a plurality of trees in bunches, and wherein installing the watering tower includes installing the watering tower proximate one of the bunches.

22. The method of claim 21, wherein:
the watering tower is a relatively tall watering tower;
the watering tower is part of a watering system that further comprises a relatively short watering tower; and
the method further comprises locating the relatively shorter watering tower between two of the bunches.

23. The method of claim 18, further comprising widening the firebreak and/or fuel breaks such that the firebreak has a width of at least 100 ft., and such that the total combined width of the firebreak and adjacent fuel breaks is at least 200 ft.

24. The method of claim 18, further comprising relocating below grade a powerline that was previously located above grade in the firebreak and/or the fuel break.

25. The method of claim 18, further comprising removing all vegetation in the fuel breaks that is within 125 ft. or more of an electrical transformer and/or an electrical power station.

26. A method of maintaining vegetation within a fuel break that is located adjacent to a firebreak, and that includes a watering tower according to claim 1, the method comprising at least one of:
causing the watering tower to apply water to the vegetation when a fire is approaching the fuel break;
causing the watering tower to apply water to the vegetation during a drought; and
causing the watering tower to apply water to the vegetation immediately before and/or during application of a backfire to at least one of the firebreak and the fuel break.
